(19) United States
(12) Patent Application Publication
(10) Pub. No.: US 2015/0006229 A1
(43) Pub. Date: Jan. 1, 2015

(54) Product transition for chain of stores with sales velocity based replenishment cutoff

(71) Applicant: Mohit Juneja, Fremont, CA (US)

(72) Inventor: Mohit Juneja, Fremont, CA (US)

(21) Appl. No.: 13/848,572

(22) Filed: Jul. 1, 2013

(51) Int. Cl. G06Q 30/00

(52) U.S. Cl. CPC G06Q 30/00
USPC 705/7.25

(57) ABSTRACT

This invention relates to the assortment of new products into a chain of stores in a manner that maximizes profit for a store-product combination utilizing average weekly gross margin return on inventory investment (GMROII). Typical product assortment logic relies on store groupings to determine which stores should carry which products. The assortment decision is also taken by grouping products together by product characteristics like brand, size, color etc. Utilizing average weekly gross margin return on inventory investment as a criterion for assorting products implies making the product assortment decision at the store—product level instead of at a group of stores—product characteristic level. Also, by utilizing the profit contributed by a product—store combination as one of the primary criteria in assortment, it is possible to improve margins for the store chain.

### TECHNICAL FIELD AND INDUSTRIAL APPLICABILITY OF INVENTION

This invention relates to the assortment of new products into a chain of stores in a manner that maximizes profit for a store-product combination utilizing average weekly gross margin return on inventory investment (GMROII).

### BACKGROUND OF THE INVENTION

Profitable assortment of products across a chain of stores is important while selecting products that each store within a chain of stores should carry. Traditionally retailers have relied on selecting products utilizing criteria such as location of store (example: beach store vs an urban store), demographics (example: average income in the surrounding area) and store size (example: large format store vs a small format store). While such groupings are useful in selecting products, they ignore profitability. Traditional assortment criteria also utilize product characteristics such as brand, size, color etc to make the assortment decision at a store group—product characteristic level. Average weekly gross margin return on inventory investment (GMROII) is a metric that measures profitability of a store product combination.

Average weekly GMROII=Sum of gross margin (profit) for a period/sum of average inventory cost for each week in that period

Product store combinations with a average weekly GMROII >1 are profitable while product store combinations with a average weekly GMROII <1 are unprofitable. By computing and applying this criterion while deciding product assortments for each store, a chain of stores can significantly improve its profitability by ensuring it carries products that generate profit at each store. This criterion helps make the product assortment decision at a more granular store-product level to help improve profitability for the store chain.

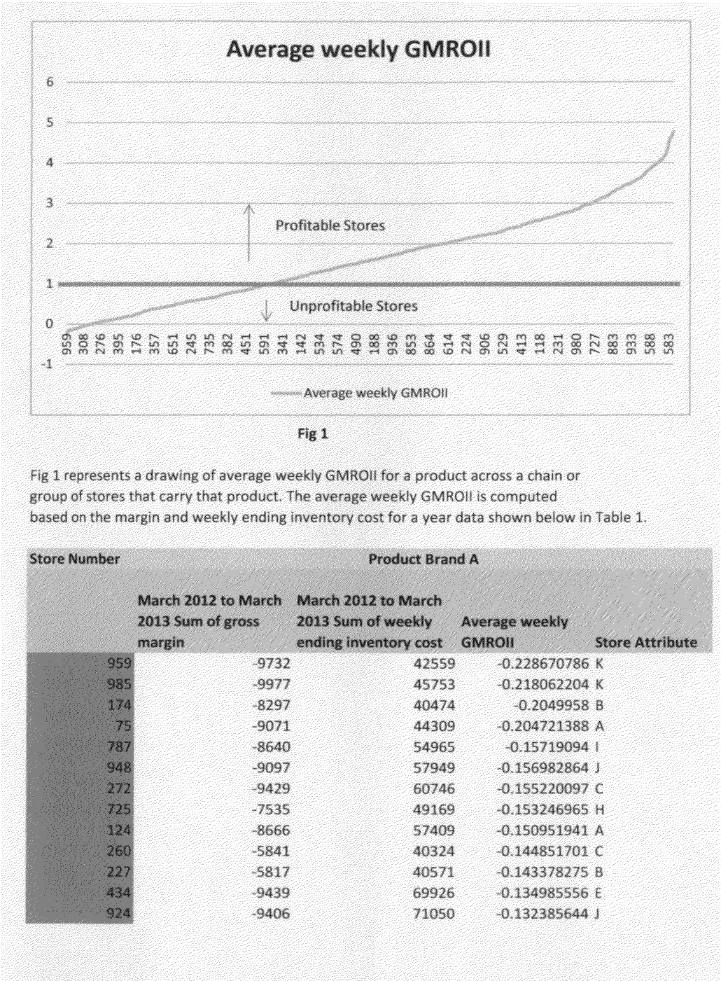

The FIG. 1 in the attached diagrams shows an average weekly GMROII plot across stores utilizing profit and inventory data shown in Table 1 for a Product Brand A. The data in Table 1 is described below:

Store number: Unique identifier for each store

March 2012 to March 2013 Sum of gross margin (USD): Represents gross margin for product brand A in that store from March 2012 to March 2013 measured in United States Dollar.

March 2012 to March 2013 Sum of weekly ending inventory cost (USD): Represents sum of weekly ending inventory cost for product brand A at that store from March 2012 to March 2013 measured in United States Dollar.

Average weekly GMROII: For product brand A at each store this is computed as=March 2012 to March 2013 Sum of gross margin (USD)/March 2012 to March 2013 Sum of weekly ending inventory cost (USD).

Store attribute: This is a store grouping that represents traditional ways like location of grouping stores for assortment purposes.

The plot in FIG. 1 shows that stores with average weekly GMROII >1 over the March 2012-March 2013 should be assorting product brand A while stores with average weekly GMROII <1 over March 2012-March 2013 should not be assorting product brand A.

What is claimed is:

1. A method to assort a product across a chain or group of stores based on average weekly gross margin return on inventory investment (GMROII) as the primary criteria. Average weekly GMROII measures profitability for a store-product combination and gives retail merchants the ability to eliminate product-store combinations that are unprofitable from the assortment. Retailers have traditionally assorted products based on store groupings such as store space, location, demographics etc.
